(19) United States
(12) Patent Application Publication
(10) Pub. No.: US 2014/0216226 A1
(43) Pub. Date: Aug. 7, 2014

(54) SYSTEM FOR FINELY CHOPPING FOOD

(71) Applicants: Bassam HOMSI, El Paso, TX (US); Carleigh Alayne HOMSI, El Paso, TX (US)

(72) Inventors: Bassam HOMSI, El Paso, TX (US); Carleigh Alayne HOMSI, El Paso, TX (US)

(21) Appl. No.: 14/166,570

(22) Filed: Jan. 28, 2014

Related U.S. Application Data
(60) Provisional application No. 61/759,893, filed on Feb. 1, 2013.

(51) Int. Cl. B26D 3/18

(52) U.S. Cl. CPC B26D 3/18
USPC 83/167

(57) ABSTRACT

A cutting system for finely chopping food items reduces physical exertion of a user and time to chop the food items while enhancing the safety of the user. The system includes a support member, a cutting sheet with a plurality of blades mounted to the support member, a block slidably mounted to the support member, a bottom member aligned with the cutting sheet and having a chopping sheet with a plurality of blades, and an upper member pivotably mounted to the bottom member. The user places a food item between the cutting sheet and the block and engages the block with the cutting sheet to cut the food item. The user maneuvers the upper member to engage with the bottom member to dice the cut food item.

### RELATED APPLICATION

The application claims priority to provisional patent application U.S. Ser. No. 61/759,893 filed on Feb. 1, 2013, the entire contents of which is herein incorporated by reference.

### BACKGROUND

The embodiments herein relate generally to systems for finely chopping food items such as fruits or vegetables.

Certain types of culinary dishes require the preparer to finely chop vegetables. For example, tabouli salad is a Middle Eastern dish that often uses finely chopped or diced parsley, tomatoes, onions and cucumbers. Individuals have to chop the vegetables by hand, which requires significant labor and time to complete. The user of a manually operated knife may become distracted or experience fatigue while chopping the vegetables. This may cause the user to suffer serious injuries such as slicing a finger.

Currently, there are limited systems for slicing, dicing or chopping food items such as food processors and blenders. However, these systems are not effective because they do not finely chop the food items as required by certain recipes. In particular, these systems often chop the food items until the resulting product is a paste.

As such, there is a need in the industry for a cutting system for finely chopping food items that overcomes the limitations of the prior art discussed above.

### SUMMARY

A cutting system for finely chopping food items reduces physical exertion of a user and time to chop the food items while enhancing the safety of the user. The system comprises a support member, a cutting sheet mounted to the support member and oriented perpendicularly to a longitudinal axis of the support member, the cutting sheet comprising a plurality of blades, a block slidably mounted to the support member, the block being configured to enable the user to place a food item between the cutting sheet and the block and engage the block with the cutting sheet, thereby cutting the food item, a bottom member aligned with the cutting sheet to collect the cut food item, the bottom member comprising a chopping sheet comprising a plurality of blades to dice the cut food item, and an upper member pivotably mounted to the bottom member and configured to enable the user to maneuver the upper member to engage with the bottom member, thereby dicing the cut food item.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the cutting system shown in use;

FIG. 2 depicts a perspective view of certain embodiments of the cutting system shown in use;

FIG. 3 depicts a perspective view of cross cutter 22 of the cutting system;

FIG. 4 depicts a section view of certain embodiments of the cutting system along line 4-4 in FIG. 1;

FIG. 5 depicts a top perspective view of push block 32 of the cutting system;

FIG. 6 depicts a bottom perspective view of push block 32 of the cutting system;

FIG. 7 depicts a section view of certain embodiments of the cutting system along line 7-7 in FIG. 2;

FIG. 8 depicts a perspective view of certain embodiments of the cutting system demonstrating the closure of lid 52;

FIG. 9 depicts a section view of certain embodiments of the cutting system along line 9-9 in FIG. 8;

FIG. 10 depicts a section view of certain embodiments of the cutting system shown in use;

FIG. 11 depicts an exploded view of certain embodiments of the cutting system;

FIG. 12 depicts a perspective view of blade tray 60 of the cutting system; and

FIG. 13 depicts a side view of an exemplary blade in blade tray blades 62.

### DETAILED DESCRIPTION OF CERTAIN EMBODIMENTS

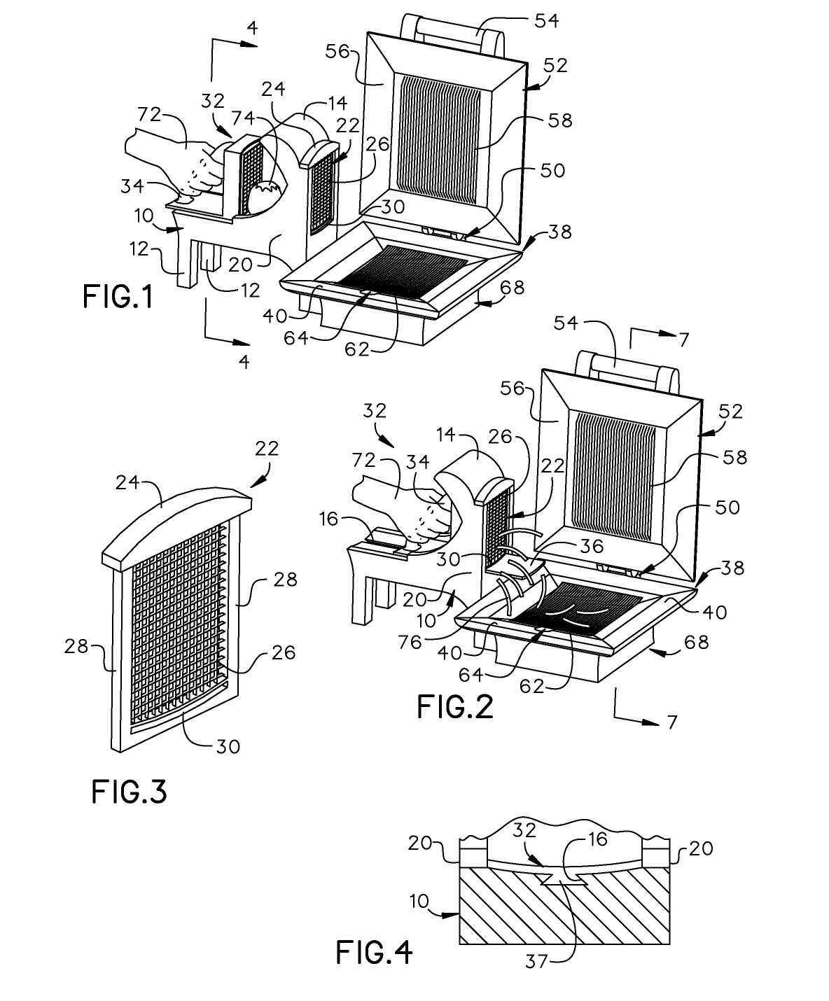

As depicted in FIGS. 1-3, the cutting system is operated by user 72 and is configured for use with food item 74 and sliced food item 76. Food item 74 may be any food item including, but not limited to, vegetables, herbs, fruits, meats, or the like. The cutting system includes cutter 10, which comprises cutter feet 12, cutter handle 14, cutter track 16 and cutter side wall 20. Cutter feet 12 may comprise a rubber outer layer to prevent cutter 10 from sliding when placed on a flat surface. Cutter 10 has dimensions of approximately 12″ in length and 5″ in width. Cross cutter 22, cross cutter handle 24, cross cutter blade grid 26, cross cutter frame 28 and cross cutter slot 30 are slidably mounted to cutter 10 via a track (not shown). The area of cross cutter blade grid 26 has approximate dimensions of 4″×5″, and comprises a set of razor sharp stainless steel blades oriented in a grid-like pattern. In a preferred embodiment, the spacing between the blades is ¼″ or less. It shall be appreciated that the blades in blade grid 26 may be oriented in any shape, e.g., squares or triangles. The cutting system further comprises push block 32, push block handle 34 and push block tongue 36. Push block 32 is slidably mounted to cutter 10 via cutter track 16.

The cutting system further comprises chopping board frame 38, chopping board frame slope 40, blade tray blades 62, blade tray clip region 64, bowl 68, lid 52, lid handle 54, lid perimeter slope 56 and lid blades 58. Lid 52 is pivotably mounted to chopping board frame 38 by hinge 50. In a preferred embodiment, chopping board frame 38 has dimensions of 12″×12″×2″ with a central aperture with dimensions of 9″×8″ to accommodate blade tray blades 62. Bowl 68 has approximate dimensions of 11″×11″×4″. Chopping board frame 38 may be secured to the side of cutter 10 by using any fastening components (not shown) such as magnets, snap components, or the like.

Blade tray blades 62 comprise a plurality of contoured razor sharp stainless steel blades oriented parallel to one another. The blades have dimensions of 7″×½″ and are separated from one another by ⅛″ or 1/16″. In a preferred embodiment, there are 48 blades. However, it shall be appreciated that any number of blades may be used. Lid blades 58 comprise a plurality of dull plastic blades oriented parallel to one another. When lid 52 is closed on top of chopping board frame 38, lid blades 58 slide through the spacing between blade tray blades 62.

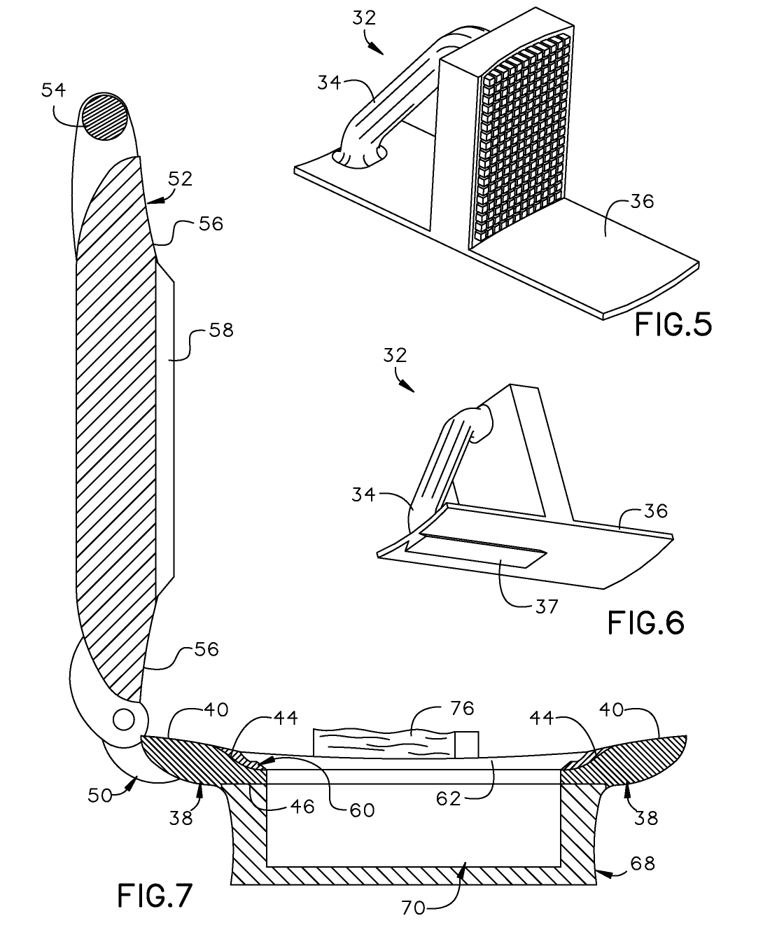

As depicted in the section view of FIG. 4, push block 32 comprises rail 37 on a bottom portion of the block, which engages with cutter track 16 of cutter 10. This allows a user to slidably adjust push block 32 along the longitudinal axis of cutter 10. In FIGS. 5-6, several perspective views of push block 32 depict push block handle 34, push block tongue 36 and push block rail 37. In a preferred embodiment, push block 32 has a height of 4″. Push block rail 37 has a length of 3″. The vertical face of push block 32 comprises a plurality of pegs oriented parallel to one another. As push block 32 slides toward cross cutter 22 on cutter 10, the plurality of pegs of push block 32 slide through the spacing between the blades of cross cutter blade grid 26. At the same time, push block tongue 36 slides through cross cutter slot 30 and is exposed on the other end of cross cutter 22.

As depicted in the FIG. 7 section view, blade tray blades 62 of blade tray 60 are placed on chopping board in frame slot 44. Bowl 68 is placed below chopping board frame 38 in chopping board frame slot 46. Bowl cavity 70 captures sliced food item 76 after it is diced by blade tray blades 62.

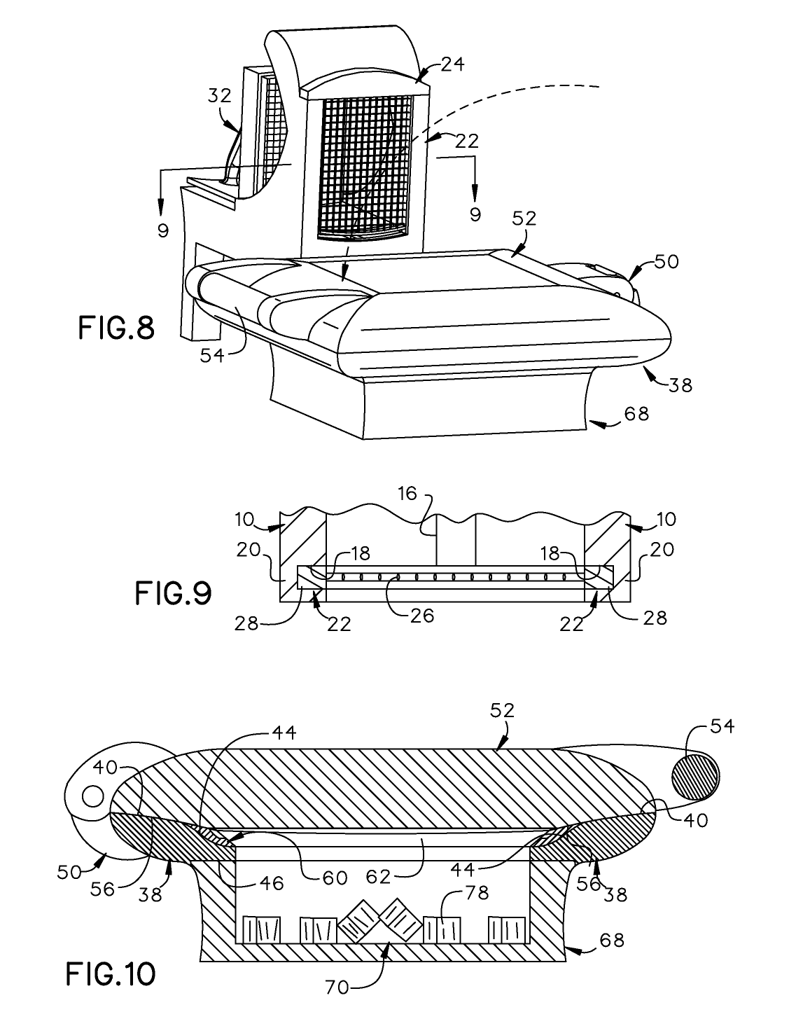

FIG. 8 depicts a perspective view of the cutting system when lid 52 is closed on top of chopping board frame 38. As depicted in the FIG. 9 section view, cross cutter 22 is slidably mounted to cutter 10 via cutter track 18. This allows a user to easily insert and remove cross cutter 22 from cutter 10. As depicted in FIG. 10, lid 52 is in the closed position above chopping board frame 38 and sliced food item 76 is diced by blade tray blades 62. The resulting diced food items 78 are collected in bowl cavity 70.

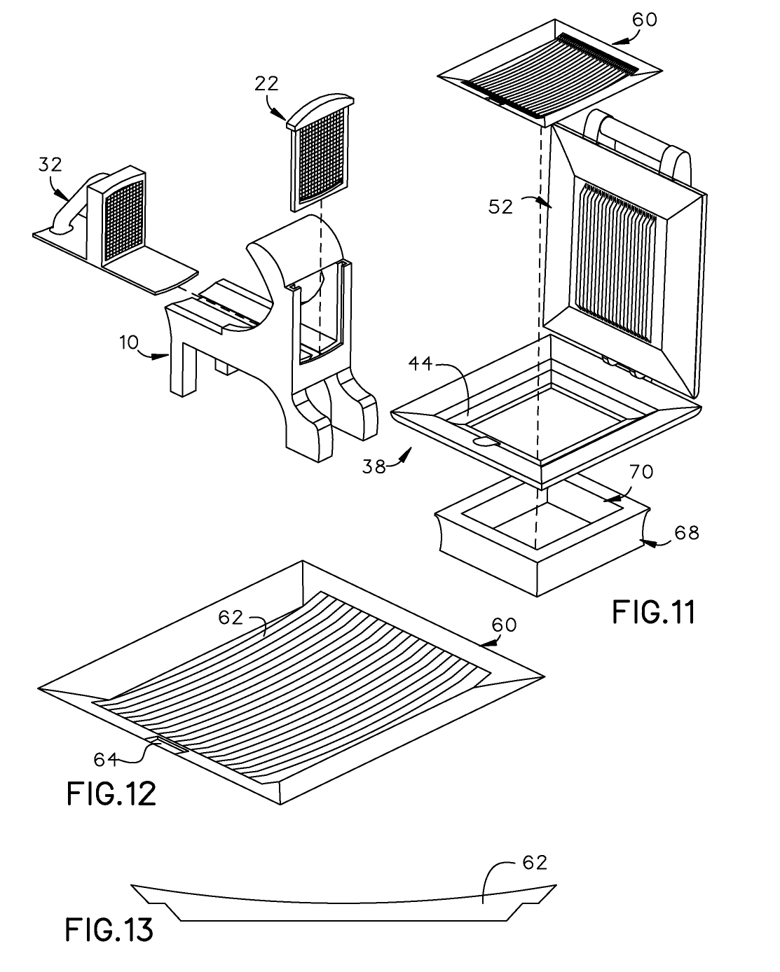

FIG. 11 depicts an exploded view of the components of the cutting system. Push block 32, cutter 10, cross cutter 22, bowl 68, chopping board frame 38, lid 52 and blade tray 60 may be easily assembled and disassembled to clean and/or store the components. FIG. 12 depicts a detailed view of blade tray 60. Blade tray clip region 64 may be used to secure blade tray 60 to chopping board frame 38. FIG. 13 depicts the curvature of each blade in blade tray blades 62. The top curved edge of the blade comprises the sharp edge, which improves the performance of blade tray 60 when chopping a food item.

In operation, a user places the cutting system on a flat surface. The user places food item 74 on push block tongue 36 of push block 32. To enhance the stability of cutter 10, the user generally places one hand on push block handle 34 and another hand on cutter handle 14. The user slides push block 32 along the length of cutter 10 to enable the pegs of push block 32 to slide through the spacing between cross cutter blade grid 26 as shown in FIG. 2. This pushes food item 74 through cross cutter 22 and onto blade tray blades 62. Once sliced food item 76 is positioned on top of blade tray blades 62, the user adjusts lid 52 to a closed position situated above chopping board frame 38. As lid 52 closes, lid blades 58 slide through the spacing between blade tray blades 62. This pushes sliced food item 76 through blade tray blades 62, and diced food items 78 are collected in bowl cavity 70. The user may repeat the process any number of times until the food item is cut and diced to a desirable state. It shall be appreciated that the cutting system significantly reduces the physical exertion of the user and time to finely chop the food items. Further, the user's safety is enhanced because his/her hands are positioned away from cross cutter 22 and blade tray blades 62 during the food cutting process.

It shall be appreciated that the components of the cutting system described in several embodiments herein may comprise any known materials in the field and be of any color, size and/or dimensions. For example, the components of the invention may be made from any type and combination of materials including, but not limited to, plastics, metals, wood, rubbers, alternate polymers, or the like. It shall be appreciated that the components of the cutting system described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A cutting system for finely chopping food items, the system being configured to reduce physical exertion of a user and time to chop the food items while enhancing the safety of the user, the system comprising:
a support member;
a cutting sheet mounted to the support member and oriented perpendicularly to a longitudinal axis of the support member, the cutting sheet comprising a plurality of blades;
a block slidably mounted to the support member, the block being configured to enable the user to place a food item between the cutting sheet and the block and engage the block with the cutting sheet, thereby cutting the food item;
a bottom member aligned with the cutting sheet to collect the cut food item, the bottom member comprising a chopping sheet comprising a plurality of blades to dice the cut food item; and
an upper member pivotably mounted to the bottom member and configured to enable the user to maneuver the upper member to engage with the bottom member, thereby dicing the cut food item.

2. The cutting system of claim 1, wherein the cutting sheet is slidably mounted to the support member and the blades of the cutting sheet are oriented in a grid-like pattern.

3. The cutting system of claim 2, wherein the block comprises a face comprising a plurality of pegs oriented parallel to one another and configured to slide through spacing between the blades of the cutting sheet.

4. The cutting system of claim 3, wherein the blades of the chopping sheet are oriented parallel to one another.

5. The cutting system of claim 4, further comprising a bowl operably connected to a bottom portion of the bottom member, wherein the bowl is configured to store the diced food item.

6. The cutting system of claim 5, wherein the upper member comprises a plurality of blades oriented parallel to one another and configured to slide through spacing between the blades of the chopping sheet.

7. The cutting system of claim 6, wherein the bottom portion of the block comprises a rail.

8. The cutting system of claim 7, wherein the top portion of the support member comprises a track situated along the longitudinal axis of the support member and configured to engage with the rail of the block.

9. The cutting system of claim 8, wherein the block comprises a tongue.

10. The cutting system of claim 9, wherein the cutting sheet comprises a slot configured to receive the tongue of the block.
